(19) United States
(12) Patent Application Publication
(10) Pub. No.: US 2018/0137565 A1
(43) Pub. Date: May 17, 2018

(54) METHOD, DEVICE, AND STORAGE MEDIUM FOR DETERMINING CREDIT SCORE

(71) Applicant: TENCENT TECHNOLOGY (SHENZHEN) COMPANY LIMITED, Shenzhen (CN)

(72) Inventor: Zheng LU, Shenzhen (CN)

(21) Appl. No.: 15/868,394

(22) Filed: Jan. 11, 2018

Related U.S. Application Data
(63) Continuation of application No. PCT/CN2016/097791, filed on Sep. 1, 2016.

(30) Foreign Application Priority Data
Sep. 7, 2015 (CN) 201510564542.6

(51) Int. Cl. G06Q 40/02

(52) U.S. Cl. CPC G06Q 40/025

(57) ABSTRACT

Credit score determining method, device, and storage medium are provided. The method includes obtaining a user group, comprising multiple users having social relationships, the multiple users containing a target user; and regarding each user in the user group, determining a current credit scoring value of the user according to a previous credit scoring value, that is after an iterative update, of another user having the social relationship with the user, and performing the iterative update until the current credit scoring value of each user in the user group meets a preset convergence result. The current credit scoring value of the target user is used as a credit scoring value of the target user.

### RELATED APPLICATIONS

This application is a continuation application of PCT Patent Application No. PCT/CN2016/097791, filed on Sep. 1, 2016, which claims priority to Chinese Patent Application No. 201510564542.6, entitled “CREDIT SCORE DETERMINING METHOD AND DEVICE” filed with the Chinese Patent Office on Sep. 7, 2015, all of which is incorporated herein by reference in their entirety.

### FIELD OF THE TECHNOLOGY

The present disclosure generally relates to the technical field of Internet, and more particularly, relates to method, device, and a storage medium for determining a credit score.

### BACKGROUND OF THE DISCLOSURE

Personal credit scoring refers to a credit evaluation mechanism including a quantitative analysis on personal credit information by a credit scoring model to provide a value according to personal credit information.

Existing personal credit score calculating technology often relies on a personal bank credit system to calculate, using basic information of a user, and use history of a band card and a credit card of the user, the personal credit score according to a computational model.

### SUMMARY

One aspect of the present disclosure provides a credit score determining method, applied to a device including at least a memory and a processor. The method includes obtaining a user group, including multiple users having social relationships, the multiple users containing a target user; and regarding each user in the user group, determining a current credit scoring value of the user according to a previous credit scoring value, that is after an iterative update, of another user having the social relationship with the user, and performing the iterative update until the current credit scoring value of each user in the user group meets a preset convergence result. The current credit scoring value of the target user is used as a credit scoring value of the target user.

Another aspect of the present disclosure provides a credit score determining device. The device includes a memory, storing program instructions for a credit score determining method, and a processor, coupled to the memory and, when executing the program instructions, configured to: obtain a user group, including multiple users having social relationships, the multiple users containing a target user; and regarding each user in the user group, determine a current credit scoring value of the user according to a previous credit scoring value that is after an iterative update of another user having the social relationship with the user, and perform the iterative update until the current credit scoring value of each user in the user group meets a preset convergence result. The current credit scoring value of the target user is used as a credit scoring value of the target user.

Another aspect of the present disclosure provides a non-transitory computer-readable storage medium, containing computer-executable program instructions, for, when executed by a processor, performing a credit score determining method. The method includes obtaining a user group, including multiple users having social relationships, the multiple users containing a target user; and regarding each user in the user group, determining a current credit scoring value of the user according to a previous credit scoring value, that is after an iterative update, of another user having the social relationship with the user, and performing the iterative update until the current credit scoring value of each user in the user group meets a preset convergence result. The current credit scoring value of the target user is used as a credit scoring value of the target user.

### BRIEF DESCRIPTION OF THE DRAWINGS

To describe the technical solutions in the embodiments of the present disclosure or in the existing technology more clearly, the following briefly describes the accompanying drawings required for describing the embodiments or the existing technology. Apparently, the accompanying drawings in the following description show merely the embodiments of the present disclosure, and a person of ordinary skill in the art may still derive other drawings from the provided drawings without creative efforts.

FIG. 1 is a flowchart of an exemplary credit score determining method according to some embodiments of the present disclosure;

FIG. 2 is a schematic diagram of an exemplary social relationship chart according to some embodiments of the present disclosure;

FIG. 3 is a flowchart of another exemplary credit score determining method according to some embodiments of the present disclosure;

FIG. 4 is a flowchart of still another exemplary credit score determining method according to some embodiments of the present disclosure;

FIG. 5 is a flowchart of still another exemplary credit score determining method according to some embodiments of the present disclosure;

FIG. 6 is a schematic structural diagram of an exemplary credit score determining device according to some embodiments of the present disclosure;

FIG. 7 is a schematic structural diagram of an exemplary score update unit according to some embodiments of the present disclosure;

FIG. 8 is a schematic structural diagram of an exemplary current credit scoring value determining unit according to some embodiments of the present disclosure;

FIG. 9 is a schematic structural diagram of an exemplary convergence determining unit according to some embodiments of the present disclosure;

FIG. 10 is a schematic structural diagram of an exemplary user group obtaining unit according to some embodiments of the present disclosure;

FIG. 11 is a schematic diagram of a hardware structure of an exemplary server according to some embodiments of the present disclosure; and

FIG. 12 is a schematic structural diagram of an exemplary terminal according to some embodiments of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

Various embodiments provide credit score determining method, device, and storage medium. For example, a user group, including multiple users having social relationships, may be obtained. The multiple users contain a target user. Because the users in the user group have social relationships, an actual credit score of each user is relatively close. In the present disclosure, regarding each user in the user group, a current credit scoring value of the user is determined according to a previous credit scoring value that is after an iterative update of the another user having the social relationship with the user, and the iterative update is performed until the current credit scoring value of each user in the user group meets a preset convergence result. The credit scoring value of the target user is then determined.

FIG. 1 is a flowchart of an exemplary credit score determining method according to some embodiments of the present disclosure.

As shown in FIG. 1, the method includes exemplary steps S100 to S120.

In S100: Obtaining a user group, the user group including multiple users having social relationships, and the multiple users containing a target user.

The target user may be a user whose credit scoring value cannot be calculated according to an existing credit score calculation model, or the calculated credit scoring value is inaccurate.

To represent intimacy of the social relationships among the users in the user group, a concept of intimacy level among the users may be brought in this exemplary embodiment, and the intimacy of the social relationship between the users is represented by using an intimacy level value between the users. The intimacy level value may be determined according to social communication traffic between two users, or may be manually set. The intimacy level value generally is smaller than 1.

Each user in the user group may calculate to obtain an initial credit scoring value according to an existing credit score calculation model. Certainly, when a credit scoring value of a user cannot be calculated according to the existing model, the initial credit scoring value of the user may be directly set to 0, or the initial credit scoring value of the user may be determined according to the initial credit scoring values of the users having the social relationships with the user. For example, an average value of the initial credit scoring values of the users having the social relationships with the user is set as the initial credit scoring value of the user.

In S110: Regarding each user in the user group, determining a current credit scoring value of the user according to a previous credit scoring value that is after an iterative update of the another user having the social relationship with the user, and performing the iterative update until the current credit scoring value of each user in the user group meets a preset convergence result.

In S120: Determining the current credit scoring value of the target user as a credit scoring value of the target user.

By performing iterative update on the credit scoring value of each user in the user group, the credit scoring values of the users entirely approach virtual values. When it is determined that the current credit scoring values of all users meet the preset convergence result, the current credit scoring values of all users in the group may be considered to reach the standard. In this case, the current credit scoring value of the target user is determined as a final credit scoring value.

Certainly, because the current credit scoring values of all users meet the preset convergence result, the current credit scoring value of each user in the group reaches the standard, and the current credit scoring value of a user from other users except the target user in the user group may further be determined as an adjusted credit scoring value of the user.

According to the credit score determining method provided in this exemplary embodiment of the present disclosure, a user group is first obtained, where the user group includes multiple users having social relationships, and the multiple users contain a target user. The target user may be a user that lacks of a credit score or the credit score is inaccurate. Because the users in the user group have social relationships, an actual credit score of each user is relatively close. In the present disclosure, regarding each user in the user group, a current credit scoring value of the user is determined according to a previous credit scoring value that is after an iterative update of the another user having the social relationship with the user, and the iterative update is performed until the current credit scoring value of each user in the user group meets a preset convergence result; and the credit scoring value of the target user is determined. The present disclosure provides technical solutions to adjust or determine a final credit scoring value of the target user according to credit scoring values of other users in a social circle of the target user, thereby improving accuracy of a credit score of the user.

Optionally, it can be learned from the foregoing solutions that the credit scoring value of the user is affected by the credit scoring values of the users having the social relationships with the user. In turn, the credit scoring value of the user also affects the credit scoring values of the users having the social relationships with the user. It may be understood that for two users having the social relationship, a farther social relationship, that is, a smaller intimacy level value indicates less impact on the credit scoring value of the other party.

Therefore, to reduce calculation complexity, when obtaining the users having the social relationships with the target user, a relationship threshold may be set, so as to merely obtain a user whose intimacy level value to the target user is greater than the relationship threshold.

Certainly, when not considering a problem of the calculation complexity, all users having the social relationships with the target user may be added into the user group. In this way, after the foregoing solutions are implemented, an updated credit scoring value of each user in the user group may be output as a respective newest credit scoring value. Meanwhile, the credit scoring values of multiple users are updated, so that an entire efficiency of updating the credit scoring values is higher.

Further, after the user group is obtained, a social relationship chart may be established by using the social relationships among the users in the user group. The social relationship chart is composed of line segments between nodes, where the nodes represent the users, and the line segments between the nodes represent that the users represented by two nodes have a direct social relationship. Moreover, intimacy level values of the users represented by two nodes are given on the line segments.

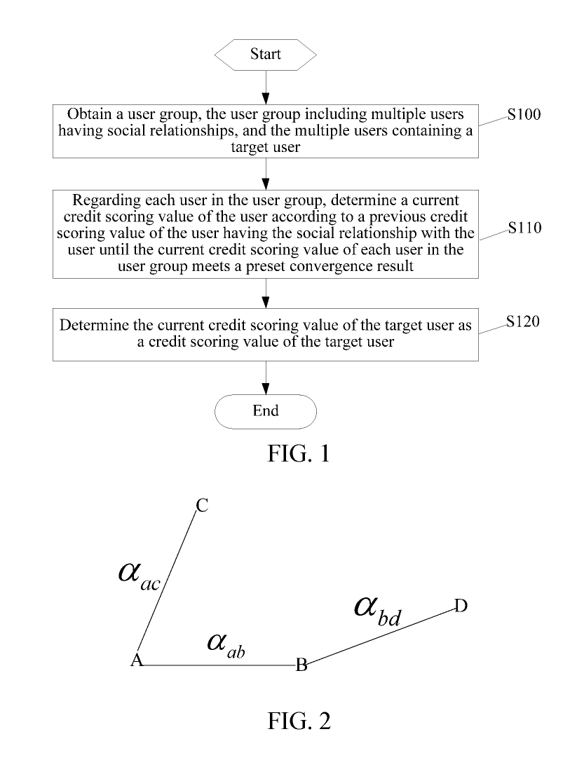

FIG. 2 is a schematic diagram of an exemplary social relationship chart according to some embodiments of the present disclosure. The social relationship chart shown in FIG. 2 includes a total of four users A, B, C, and D. The social relationships are divided into direct social relationships and indirect social relationships. An intimacy level value of two users having the direct social relationship may be set to 0.

Users having direct social relationships with A are B and C; users having direct social relationships with B are A and D; a user having a direct social relationship with C is A; and a user having a direct social relationship with D is B. The social relationships between the remaining users are indirect social relationships.

An intimacy level value between users A and B is α_{ab}, an intimacy level value between users A and C is α_{ac}, and an intimacy level value between users B and D is α_{bd}.

Through establishing a social relationship chart of the target user, the social relationships among the users in the user group are indicated more vividly in a form of a chart. After the social relationship chart is established, a process of updating the credit scoring value may be performed on each user in the social relationship chart.

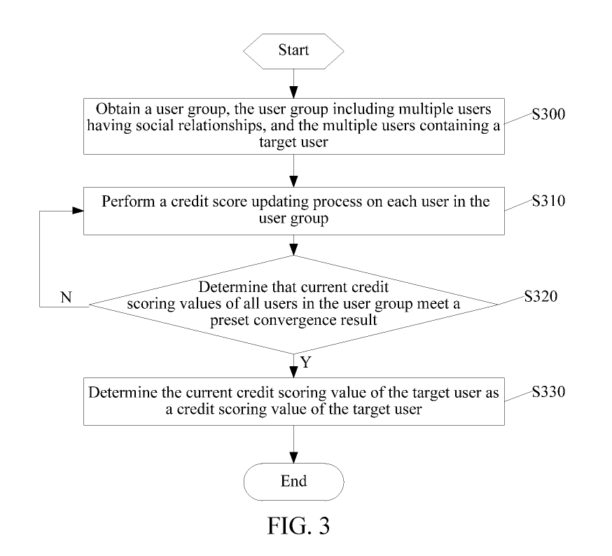

FIG. 3 is a flowchart of another exemplary credit score determining method according to some embodiments of the present disclosure.

In S300: Obtaining a user group, the user group including multiple users having social relationships, and the multiple users containing a target user.

The target user may be a user whose credit scoring value cannot be calculated according to an existing credit score calculation model, or the calculated credit scoring value is inaccurate.

In S310: Performing a credit score updating process on each user in the user group.

The credit score updating process includes: determining a current credit scoring value of the user according to a previous credit scoring value that is after an iterative update of the another user having the social relationship with the user.

In this exemplary step, the credit scoring values of all users in the user group are updated successively, and reference is made to the credit scoring values of the users having the social relationships with the user during the updating. After the credit scoring values of all users in the user group are updated for one time, the credit scoring values of the users entirely approach virtual credit scoring values.

In S320: Determining whether current credit scoring values of all users in the user group meet a preset convergence result, if not, returning to perform the exemplary step S310, and if yes, performing the exemplary step S330.

In S330: Determining the current credit scoring value of the target user as a credit scoring value of the target user.

By performing iterative update on the credit scoring value of each user in the user group, the credit scoring values of the users entirely approach virtual values. When it is determined that the current credit scoring values of all users meet the preset convergence result, the current credit scoring values of all users in the group may be considered to reach the standard. In this case, the current credit scoring value of the target user is determined as a final credit scoring value.

Certainly, the current credit scoring values of other users except the target user in the user group may further be determined as adjusted credit scoring values of the corresponding users.

This exemplary embodiment describes a specific implementation of performing iterative update on the credit scoring value of each user in the user group. By performing iterative update on the credit scoring value of each user in the user group, the credit scoring values of the users entirely approach virtual values.

In still another embodiment of the present disclosure, the foregoing process of the determining a current credit scoring value of the user by using a previous credit scoring value that is after an iterative update of the another user having the social relationship with the user is described in detail.

This exemplary embodiment provides an equation for updating credit scoring values of the users, and the credit scoring value of each user is updated according to the following equation:

$${PCS}_{i}^{t} = {PCS}_{i}^{0} + {\sum }_{j = 1 , i = 1}^{N} {α}_{ij} * {PCS}_{j}^{t - 1}$$

N is a total number of the users in the user group; PCSᵢ^{t} is a credit scoring value updated for t times of an ith user; αᵢⱼ is an intimacy level value between the ith user and a jth user, and the intimacy level value represents intimacy of the social relationship between the two users; PCSⱼ^{t-1} is a credit scoring value updated for t−1 times of the jth user; and PCSᵢ⁰ is an initial credit scoring value of the ith user.

The initial credit scoring value of a user may be calculated according to an existing calculation model. Certainly, when the existing calculation model cannot calculate the initial credit scoring value of the user, the initial credit scoring value of the user may be set as 0, or as an average value of initial credit scoring values of the users having the social relationships with the user.

Optionally, when setting the intimacy level value, the intimacy level value of the user i to the user j may be set αᵢⱼ, and the intimacy level value of the user j to the user i may be set as a αᵢⱼ. αᵢⱼ may be equal to αⱼᵢ, and certainly, αᵢⱼ may also not be equal to αⱼᵢ. The specific setting rule is set according to actual needs.

Subsequently, a convergence situation of the credit scoring value is researched.

The foregoing equation for updating credit scoring values is expressed in a form of a matrix:

$$[ \begin{matrix}{PCS}_{1}^{t} \\ {PCS}_{2}^{t} \\ {PCS}_{3}^{t} \\ ⋮ \\ {PCS}_{n}^{t}\end{matrix} ] = [ \begin{matrix}{PCS}_{1}^{0} \\ {PCS}_{2}^{0} \\ {PCS}_{3}^{0} \\ ⋮ \\ {PCS}_{n}^{0}\end{matrix} ] + [ \begin{matrix}0 & {α}_{12} & {α}_{13} & … & {α}_{1 n} \\ {α}_{21} & 0 & {α}_{23} & … & {α}_{2 n} \\ {α}_{31} & {α}_{32} & 0 & … & {α}_{3 n} \\ ⋮ & ⋮ & ⋮ & ⋱ & ⋮ \\ {α}_{n 1} & {α}_{n 2} & {α}_{n 3} & … & 0\end{matrix} ] [ \begin{matrix}{PCS}_{1}^{t - 1} \\ {PCS}_{2}^{t - 1} \\ {PCS}_{3}^{t - 1} \\ ⋮ \\ {PCS}_{n}^{t - 1}\end{matrix} ]$$

It is defined that:

$${PCS}^{( t )} = [ \begin{matrix}{PCS}_{1}^{t} \\ {PCS}_{2}^{t} \\ {PCS}_{3}^{t} \\ ⋮ \\ {PCS}_{n}^{t}\end{matrix} ] , \\ β = [ \begin{matrix}{PCS}_{1}^{0} \\ {PCS}_{2}^{0} \\ {PCS}_{3}^{0} \\ ⋮ \\ {PCS}_{n}^{0}\end{matrix} ] , \\ Q = [ \begin{matrix}0 & {α}_{12} & {α}_{13} & … & {α}_{1 n} \\ {α}_{21} & 0 & {α}_{23} & … & {α}_{2 n} \\ {α}_{31} & {α}_{32} & 0 & … & {α}_{3 n} \\ ⋮ & ⋮ & ⋮ & ⋱ & ⋮ \\ {α}_{n 1} & {α}_{n 2} & {α}_{n 3} & … & 0\end{matrix} ]$$

The equation for updating credit scoring values is expressed as:

PCS^{(t)}=β+Q*PCS^{(t-1)}

The following are deduced:

A first update is:

PCS⁽¹⁾=β+Q*PCS⁽⁰⁾=β+Q*β

A second update is:

PCS⁽²⁾=β+Q*PCS⁽¹⁾=β+Q(β+Q*β)=(I+Q+Q²)β

A third update is:

PCS⁽³⁾=(I+Q+Q²+Q³)β

An nth update is:

$${PCS}^{( n )} = ( I + Q + … + {Q}^{n} ) β = \frac{I - {Q}^{n + 1}}{I - Q} β$$

Therefore, the PCS⁽ⁿ⁾ can be converged when the Qⁿ⁺¹ is ensured to be converged.

In actual applications, a sum of intimacy levels of each user to neighboring users thereof is smaller than 1, and the neighboring users of the user are users having the social relationship with the user.

It should be noted that in the above formula, it is supposed that an intimacy level value of the user to itself is 0. The neighboring users of the user may be divided into direct neighboring users and indirect neighboring users. The direct neighboring users are users having direct social relationships with the user, and the indirect neighboring users are users having indirect social relationships with the user. An intimacy level value between the user and the direct neighboring user is not 0, and an intimacy level value between the user and the indirect neighboring user may be set to 0.

Subsequently, the credit score updating process is described in a specific exemplary embodiment.

Still referring to FIG. 2, initial credit scores of A, B, C, and D may be:

βₐ=1=A₀,β_{b}=2=B₀,β_{c}=1=C₀,β_{d}=2=D₀

α_{ab}=α_{ac}α_{ba}=α_{bd}=α_{ca}=α_{db}=0.1

A first iteration result is:

A₁=βₐ+α_{ab}B₀+α_{ac}C₀=1.3 . . . B₁=β_{b}+α_{ba}A₀+α_{bd}D₀=2.3

C₁=β_{c}+α_{ca}A₀=1.1 . . . D₁=β_{d}+α_{db}B₀=2.2

A second iteration result is:

A₂=βₐ+α_{ab}B₁+α_{ac}C₁=1.34 . . . B₂=β_{b}+α_{ba}A₁+α_{bd}D₁=2.35

C₂=β_{c}+α_{ca}A₁=1.13 . . . D₂=β_{d}+α_{db}B₁=2.23

A third iteration result is:

A₃=βₐ+α_{ab}B₂+α_{ac}C₂=1.348 . . . B₃=β_{b}+α_{ba}A₂+α_{bd}D₂=2.357

C₃=β_{c}+α_{ca}A₂=1.134 . . . D₃=β_{d}+α_{db}B₂=2.235

A fourth iteration result is:

A₄=βₐ+α_{ab}B₃+α_{ac}C₃=1.3491 . . . B₄=β_{b}+α_{ba}A₃±α_{bd}D₃=2.3583

C₄=β_{c}+α_{ca}A₃=1.1348 . . . D₄=β_{d}+α_{db}B₃=2.2357

When iteration is performed for the fourth time, a convergence result of the credit scoring values of A, B, C, and D is obtained. For example, the A₄, B₄, C₄, and D₄ are respectively very close to the A₃, B₃, C₃, and D₃, and would not change when being continuously converged. The A₄, B₄, C₄, and D₄ may be output as final values of the credit scoring values of A, B, C, and D. The A₄, B₄, C₄, and D₄ are changed as compared with initial A₀, B₀, C₀, and D₀; this is impact generated by a credit scoring value of a friend.

When A is the target user, because the current credit scoring values of all users (for example, A, B, C, and D) all meet the preset convergence result, the credit scoring values B₄, C₄, and D₄ of the users B, C, and D at this time may be taken as adjusted credit scoring values of the users B, C, and D. Certainly, the foregoing credit scoring equation is merely optional, and a person skilled in the art may make variations and improvements based on this equation.

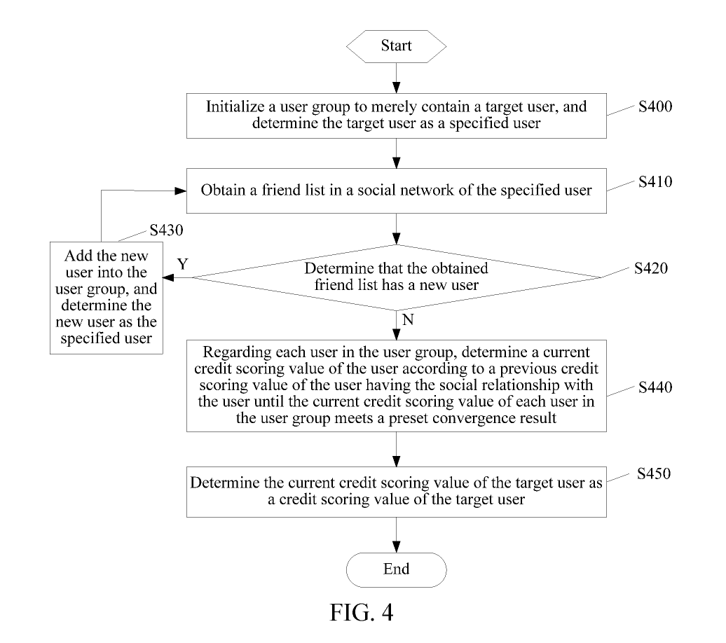

FIG. 4 is a flowchart of still another exemplary credit score determining method according to some embodiments of the present disclosure.

In S400: Initializing a user group to merely contain a target user, and determining the target user as a specified user.

In S410: Obtaining a friend list in a social network of the specified user.

In S420: Determining whether the obtained friend list has a new user, where the new user is a user that does not exist in the user group, if yes, performing the exemplary step S430, and if not, performing the exemplary step S440.

In S430: Adding the new user into the user group, determining the new user as the specified user, and returning to perform the exemplary step S410.

In S440: Regarding each user in the user group, determining a current credit scoring value of the user according to a previous credit scoring value that is after an iterative update of the another user having the social relationship with the user, and performing the iterative update until the current credit scoring value of each user in the user group meets a preset convergence result.

In S450: Determining the current credit scoring value of the target user as a credit scoring value of the target user.

The present disclosure describes an implementation of obtaining a user group having a social relationship with a target user. A friend list of a user is obtained by using a social network of the user, and a friend list of each user in the friend list is further obtained, where the operations are cyclically performed. Iterative update is performed until no new users are obtained.

Herein, the social network of the user may be various social networks such as QQ, WeChat, Weibo, Email, and contacts.

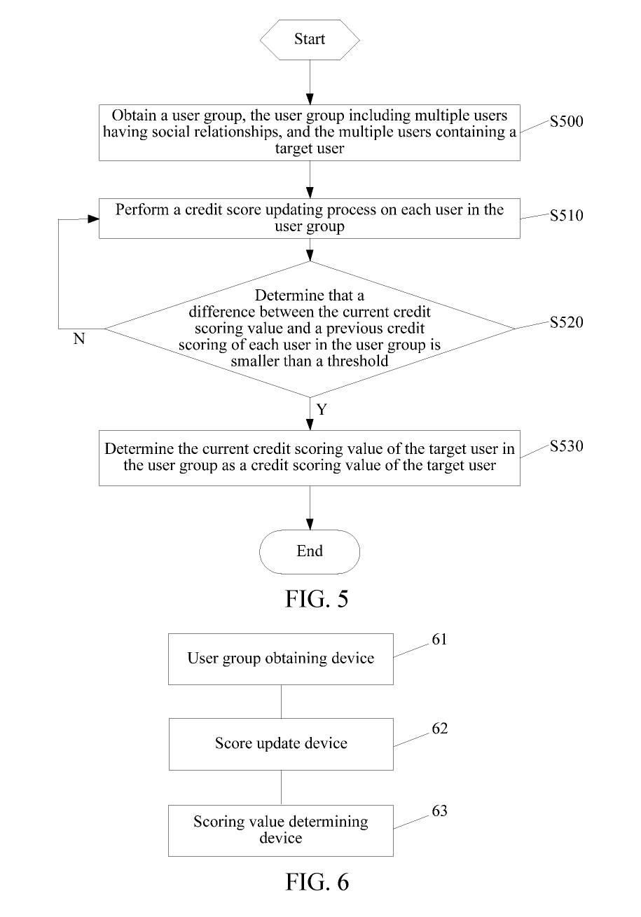

FIG. 5 is a flowchart of still another exemplary credit score determining method according to some embodiments of the present disclosure.

In S500: Obtaining a user group, the user group including multiple users having social relationships, and the multiple users containing a target user.

The target user may be a user whose credit scoring value cannot be calculated according to an existing credit score calculation model, or the calculated credit scoring value is inaccurate.

In S510: Performing a credit score updating process on each user in the user group.

The credit score updating process includes: determining a current credit scoring value of the user according to a previous credit scoring value that is after an iterative update of the another user having the social relationship with the user.

In S520: Determining whether a difference between a current credit scoring value of each user in the user group and a previous credit scoring is smaller than a threshold, when yes, performing the exemplary step S530, and if not, returning to perform the exemplary step S510.

In S530: Determining the current credit scoring value of the target user in the user group as a credit scoring value of the target user.

This exemplary embodiment describes a manner of determining whether the credit scoring value meets a convergence result. Specifically, whether the credit scoring value meets the convergence result is determined by comparing a difference between the credit scoring value before being updated and the updated credit scoring value with a threshold.

It may be understood that through the equation for updating credit scoring values that is described in the previous embodiment, after the intimacy level values between the users are determined, a convergence value of the credit scoring value of each user may be calculated in advance. Therefore, the updated credit scoring value may be compared with the convergence value every time after updating is performed, so as to determine, according to a comparison result, whether the credit scoring value updated at this time meets the convergence result.

A credit score determining device provided in the embodiments of the present disclosure is described below. Cross reference may be made to the credit score determining device that is described below and the credit score determining method that is described above.

FIG. 6 is a schematic structural diagram of an exemplary credit score determining device according to some embodiments of the present disclosure.

As shown in FIG. 6, the exemplary credit score determining device includes:

a user group obtaining device 61, configured to obtain a user group, the user group including multiple users having social relationships, and the multiple users containing a target user;

a score update device 62, configured to, regarding each user in the user group, determine a current credit scoring value of the user according to a previous credit scoring value that is after an iterative update of the another user having the social relationship with the user, and perform the iterative update until the current credit scoring value of each user in the user group meets a preset convergence result; and

a scoring value determining device 63, configured to determine the current credit scoring value of the target user as a credit scoring value of the target user.

According to the credit score determining device provided in this exemplary embodiment of the present disclosure, a user group is first obtained, where the user group includes multiple users having social relationships, and the multiple users contain a target user. The target user may be a user that lacks of a credit score or the credit score is inaccurate. Because the users in the user group have social relationships, an actual credit score of each user is relatively close. In the present disclosure, regarding each user in the user group, a current credit scoring value of the user is determined according to a previous credit scoring value that is after an iterative update of the another user having the social relationship with the user, and the iterative update is performed until the current credit scoring value of each user in the user group meets a preset convergence result; and the credit scoring value of the target user is determined. The solutions of the present disclosure adjust or determine a final credit scoring value of the target user according to credit scoring values of other users in a social circle of the target user, thereby improving accuracy of a credit score of the user.

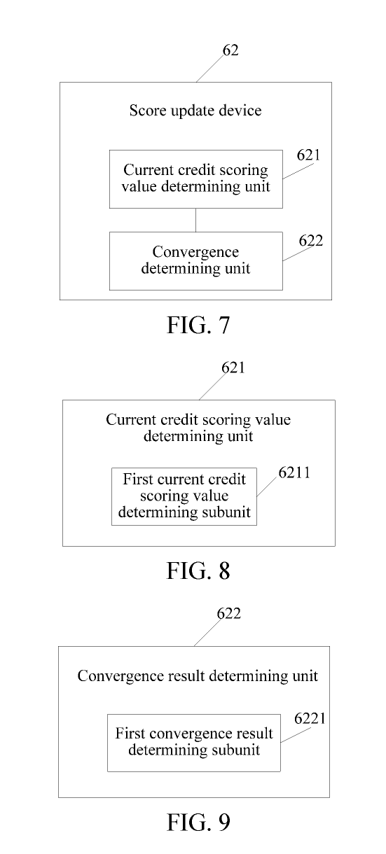

Optionally, this exemplary embodiment of the present disclosure discloses an optional structure of the foregoing score update device 62. As shown in FIG. 7, the score update device 62 may include:

a current credit scoring value determining unit 621, configured to perform a credit score updating process on each user in the user group, where the credit score updating process includes: the determining a current credit scoring value of the user according to a previous credit scoring value that is after an iterative update of the another user having the social relationship with the user; and

a convergence determining unit 622, configured to determine whether the current credit scoring value of each user in the user group meets the preset convergence result, of not, returning to implement the current credit scoring value determining unit 621, and if yes, ending the operation.

Optionally, this exemplary embodiment of the present disclosure discloses an optional structure of the foregoing current credit scoring value determining unit 621. As shown in FIG. 8, the current credit scoring value determining unit 621 may include:

a first current credit scoring value determining subunit 6211, configured to determine the current credit scoring value of the user according to the following formula:

$${PCS}_{i}^{t} = {PCS}_{i}^{0} + {\sum }_{j = 1 , i = 1}^{N} {α}_{ij} * {PCS}_{j}^{t - 1}$$

N is a total number of the users in the user group; PCSᵢ^{t} is a credit scoring value updated for t times of an ith user; αᵢⱼ is an intimacy level value between the ith user and a jth user, and the intimacy level value represents intimacy of the social relationship between the two users; and PCSⱼ^{t-1} is a credit scoring value updated for t−1 times of the jth user.

Optionally, this exemplary embodiment of the present disclosure discloses an optional structure of the foregoing convergence determining unit 622. As shown in FIG. 9, the convergence determining unit 622 may include:

a first convergence determining subunit 6221, configured to determine whether a difference between the current credit scoring value of each user in the user group and a previous credit scoring value that is after an iterative update is smaller than a threshold, when yes, determine that the current credit scoring value of each user in the user group meets the preset convergence result, and if not, determine that the updated credit scoring value of each user in the user group does not meet the preset convergence result.

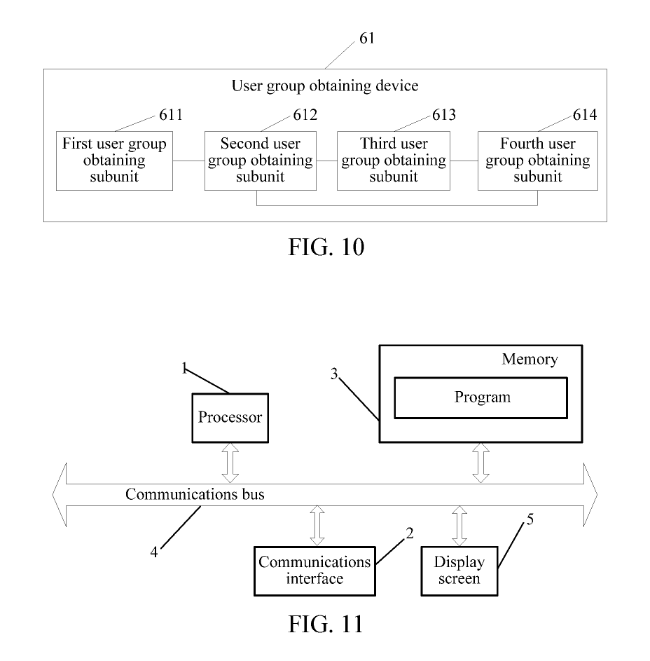

Optionally, this exemplary embodiment of the present disclosure discloses an optional structure of the foregoing user group obtaining device 61. As shown in FIG. 10, the user group obtaining device 61 may include:

a first user group obtaining subunit 611, configured to initialize the user group to include the target user only, and determine the target user as a specified user;

a second user group obtaining subunit 612, configured to obtain a friend list in a social network of the specified user;

a third user group obtaining subunit 613, configured to determine whether the obtained friend list has a new user, where the new user is a user that does not exist in the user group, when yes, perform a fourth user group obtaining subunit 614, and if not, end the operation; and

the fourth user group obtaining subunit 614, configured to add the new user into the user group, determine the new user as the specified user, and then return to implement the second user group obtaining subunit 612.

The embodiments of the present disclosure further provide a server that includes the foregoing credit score determining device. Reference may be made to the foregoing corresponding descriptions for the credit score determining device, and is not described in detail herein again.

This exemplary embodiment describes a hardware structure of the server. Referring to FIG. 11, FIG. 11 is a schematic diagram of a hardware structure of a server according to some embodiments of the present disclosure. As shown in FIG. 11, the server may include:

A processor 1, a communications interface 2, a memory 3, a communications bus 4, and a display screen 5.

The processor 1, the communications interface 2, the memory 3, and the display screen 5 communicate with each other through the communications bus 4.

Optionally, the communications interface 2 may be an interface of a communication module, for example, an interface of a GSM module;

the processor 1 is configured to implement a program;

the memory 3 is configured to store the program; and

the program may include program code that includes an operation instruction of the processor.

The processor 1 may be a central processing unit (CPU), or an application-specific integrated circuit (ASIC), or is configured as one or more integrated circuits implementing this exemplary embodiment of the present disclosure.

The memory 3 may include a high-speed RAM memory, or may include a non-volatile memory, for example, at least one magnetic disk storage.

The program may be specifically configured to:

obtain a user group, the user group including multiple users having social relationships, and the multiple users containing a target user;

regarding each user in the user group, determine a current credit scoring value of the user according to a previous credit scoring value that is after an iterative update of the another user having the social relationship with the user, and perform the iterative update until the current credit scoring value of each user in the user group meets a preset convergence result; and

determine the current credit scoring value of the target user as a credit scoring value of the target user.

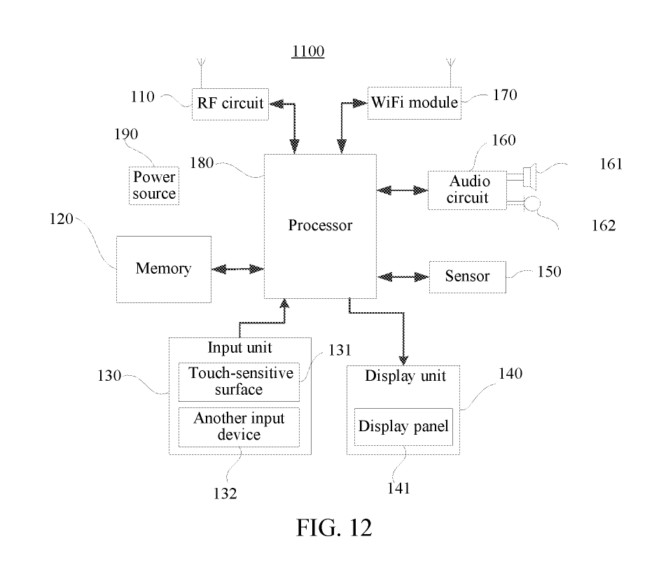

FIG. 12 is a block diagram of a credit scoring value determining terminal 1100 according to some embodiments of the present disclosure. Referring to FIG. 12, the terminal 1100 may include:

components such as a RF (Radio Frequency) circuit 110, a memory 120 including one or more computer-readable storage media, an input unit 130, a display unit 140, a sensor 150, an audio circuit 160, a WiFi (Wireless Fidelity) module 170, a processor 180 including one or more processing cores, and a power source 190. A person skilled in the art may understand that the terminal structure shown in FIG. 12 does not constitute a definition to the terminal, and the terminal may include more components or fewer components than those shown in the figure, or some components may be combined, or a different component deployment may be used. Herein:

The RF circuit 110 may be configured to receive and send signals during an information receiving and sending process or a call process. Particularly, the RF circuit 110 receives downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communication standard or protocol, which includes, but is not limited to, Global System for Mobile Communications (GSM), General Packet Radio Service (GPRS), Code Division Multiple Access (CDMA), Wideband Code Division Multiple Access (WCDMA), Long Term Evolution (LTE), e-mail, SMS (Short Messaging Service), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 1100, and the like. In addition, the memory 120 may include a high speed random access memory, and may also include a non-volatile memory, such as at least one magnetic disk storage device, a flash memory, or another volatile solid-state storage device. Correspondingly, the memory 120 may further include a memory controller, so that as to provide access of the processor 180 and the input unit 130 access to the memory 120.

The input unit 130 may be configured to receive input digit or character information, and generate a keyboard, mouse, joystick, optical, or track ball signal input related to the user setting and function control. Specifically, the input unit 130 may include a touch-sensitive surface 131 and another input device 132. The touch-sensitive surface 131, which may also be referred to as a touchscreen or a touch panel, may collect a touch operation of a user on or near the touch-sensitive surface (such as an operation of a user on or near the touch-sensitive surface 131 by using any suitable object or accessory, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be may be a resistive, capacitive, infrared, or surface sound wave type touch-sensitive surface. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user interfaces of the terminal 1100. The graphical user interfaces may be formed by a graph, a text, an icon, a video, or any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine the a type of the a touch event. Then, the processor 180 provides a corresponding visual output on the display panel 141 according to the type of the touch event. Although, in FIG. 11, the touch-sensitive surface 131 and the display panel 141 are used as two separate parts to implement input and output functions, in some embodiments, the touch-sensitive surface 131 and the display panel 141 may be integrated to implement the input and output functions.

The terminal 1100 may further include at least one sensor 150, such as an optical sensor, a motion sensor, and other sensors. Specifically, the optical sensor may include an ambient light sensor and a proximity sensor. The ambient light sensor can adjust luminance of the display panel 141 according to brightness of the ambient light. The proximity sensor may switch off the display panel 141 and/or backlight when the terminal 1100 is moved to the ear. As one type of motion sensor, a gravity acceleration sensor can detect magnitude of accelerations in various directions (generally on three axes), may detect magnitude and a direction of the gravity when static, and may be applied to an application that recognizes the attitude of a mobile phone (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the terminal 1100, are not further described herein.

The audio circuit 160, a speaker 161, and a microphone 162 may provide audio interfaces between the user and the terminal 1100. The audio circuit 160 may convert received audio data into an electric signal and transmit the electric signal to the speaker 161. The speaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 1100.

WiFi is a short distance wireless transmission technology. The terminal 1100 may help, by using a WiFi module 170, the user to receive and send e-mails, browse a web page, access streaming media, and so on, which provides wireless broadband Internet access for the user. Although FIG. 12 shows the WiFi module 170, it may be understood that the WiFi module is not a necessary component of the terminal 1100, and when required, the WiFi module may be omitted as long as the scope of the essence of the present disclosure is not changed.

The processor 180 is the control center of the terminal 1100, and is connected to various parts of the mobile phone by using various interfaces and lines. By running or executing the software program and/or module stored in the memory 120, and invoking data stored in the memory 120, the processor 180 performs various functions and data processing of the terminal 1100, thereby performing overall monitoring on the mobile phone. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that the foregoing modem may also not be integrated into the processor 180.

The terminal 1100 further includes the power supply 190 (such as a battery) for supplying power to the components. Preferably, the power supply may be logically connected to the processor 180 by using a power management system, thereby implementing functions such as charging, discharging and power consumption management by using the power management system. The power supply 190 may further include one or more of a direct current or alternating current power supply, a re-charging system, a power failure detection circuit, a power supply converter or inverter, a power supply state indicator, and any other components.

Although not shown in the figure, the terminal 1100 may further include a camera, a Bluetooth module, and the like, which are not further described herein. Specifically, in this exemplary embodiment, the display unit of the terminal is a touchscreen display, and the terminal further includes a memory and one or more programs. The one or more programs are stored in the memory and configured to be executed by one or more processors. The one or more programs contain instructions used for implementing the following operations: obtaining a user group, the user group including multiple users having social relationships, and the multiple users containing a target user; regarding each user in the user group, determining a current credit scoring value of the user according to a previous credit scoring value that is after an iterative update of the another user having the social relationship with the user, and performing the iterative update until the current credit scoring value of each user in the user group meets a preset convergence result; and determining the current credit scoring value of the target user as a credit scoring value of the target user.

The one or more programs further contain instructions used for implementing other operations in the credit score determining method in FIG. 3, FIG. 4, or FIG. 5.

According to various embodiments of the present disclosure, a user group is first obtained, where the user group includes multiple users having social relationships, and the multiple users contain a target user. The target user may be a user that lacks of a credit score or the credit score is inaccurate. Because the users in the user group have social relationships, an actual credit score of each user is relatively close. In the present disclosure, regarding each user in the user group, a current credit scoring value of the user is determined according to a previous credit scoring value that is after an iterative update of another user having the social relationship with the user, and the iterative update is performed until the current credit scoring value of each user in the user group meets a preset convergence result; and the credit scoring value of the target user is determined.

The present disclosure provides technical solutions by adjusting or determining the credit scoring value of the target user according to credit scoring values of other users in a social circle of the target user, thereby improving accuracy of the credit score of the user. As a result, a technical problem that a personal credit score of a user cannot be accurately calculated when nonsufficient information of the user is obtained by an existing calculation solution for a personal credit score may be solved.

Finally, it should be noted that the relational terms herein such as first and second are used only to differentiate an entity or operation from another entity or operation, and do not require or imply any actual relationship or sequence between these entities or operations. Moreover, the terms “include”, “comprise”, and any variants thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. Unless otherwise specified, an element limited by “include a/an . . . ” does not exclude other same elements existing in the process, the method, the article, or the device that includes the element.

The embodiments in this specification are all described in a progressive manner. Description of each of the embodiments focuses on differences from other embodiments, and reference may be made to each other for the same or similar parts among respective embodiments.

The foregoing descriptions of the disclosed embodiments enable a person skilled in the art to implement or use the present disclosure. Various modifications to the embodiments are obvious to a person skilled in the art, and general principles defined in this specification may be implemented in other embodiments without departing from the spirit or scope of the present disclosure. Therefore, the present disclosure will not be limited to the embodiments described in this specification but extends to the widest scope that complies with the principles and novelty disclosed in this specification.

What is claimed is:

1. A credit score determining method, applied to a device including at least a memory and a processor, the method comprising:
obtaining a user group, comprising multiple users having social relationships, the multiple users containing a target user; and
regarding each user in the user group, determining a current credit scoring value of the user according to a previous credit scoring value, that is after an iterative update, of another user having the social relationship with the user, and performing the iterative update until the current credit scoring value of each user in the user group meets a preset convergence result, wherein the current credit scoring value of the target user is used as a credit scoring value of the target user.

2. The method according to claim 1, wherein, regarding each user in the user group, determining the current credit scoring value of the user comprises:
performing a credit score updating process on each user in the user group, by:
determining a current credit scoring value of the user according to a previous credit scoring value that is after an iterative update of another user having the social relationship with the user; and
determining whether the current credit scoring value of each user in the user group meets the preset convergence result,
when the current credit scoring value of each user in the user group does not meet the preset convergence result, returning to performing the credit score updating process on each user in the user group, and
when the current credit scoring value of each user in the user group meets the preset convergence result, ending the operation.

3. The method according to claim 2, wherein determining the current credit scoring value of the user according to the previous credit scoring value that is after the iterative update of the another user having the social relationship with the user comprises:
determining the current credit scoring value of the user according to a formula:
$${PCS}_{i}^{t} = {PCS}_{i}^{0} + {\sum }_{j = 1 , i = 1}^{N} {α}_{ij} * {PCS}_{j}^{t - 1} ,$$
wherein
N is a total number of the users in the user group; PCSᵢ^{t} is a credit scoring value updated fort times of an ith user, αᵢⱼ is an intimacy level value between the ith user and a jth user, and the intimacy level value representing intimacy of the social relationship between the two users, PCSⱼ^{t-1} is a credit scoring value updated for t−1 times of the jth user, and PCSᵢ⁰ an initial credit scoring value of the ith user.

4. The method according to claim 2, wherein determining whether the current credit scoring value of each user in the user group meets the preset convergence result comprises:
determining whether a difference between the current credit scoring value of each user in the user group and the previous credit scoring value that is after an iterative update is smaller than a threshold, if yes, determining that the current credit scoring value of each user in the user group meets the preset convergence result, and if not, determining that the updated credit scoring value of each user in the user group does not meet the preset convergence result.

5. The method according to claim 1, wherein obtaining the user group comprises:
initializing the user group to merely contain the target user, and determining the target user as a specified user;
obtaining a friend list in a social network of the specified user; and
determining whether the obtained friend list has a new user, wherein the new user is a user that does not exist in the user group,
if yes, adding the new user into the user group, determining the new user as the specified user, and returning to perform the step of the obtaining a friend list in a social network of the specified user, and
if not, ending the operation.

6. A credit score determining device, comprising:
a memory, storing program instructions for a credit score determining method, and
a processor, coupled to the memory and, when executing the program instructions, configured to:
obtain a user group, comprising multiple users having social relationships, the multiple users containing a target user; and
regarding each user in the user group, determine a current credit scoring value of the user according to a previous credit scoring value that is after an iterative update of another user having the social relationship with the user, and perform the iterative update until the current credit scoring value of each user in the user group meets a preset convergence result, wherein the current credit scoring value of the target user is used as a credit scoring value of the target user.

7. The device according to claim 6, wherein the processor is further configured to:
perform a credit score updating process on each user in the user group by determining a current credit scoring value of the user according to a previous credit scoring value that is after an iterative update of another user having the social relationship with the user; and
determine whether the current credit scoring value of each user in the user group meets the preset convergence result, if not, return to implement the current credit scoring value determining unit, and when yes, end the operation.

8. The device according to claim 7, wherein the processor is further configured to:
determine the current credit scoring value of the user according to the following formula:
$${PCS}_{i}^{t} = {PCS}_{i}^{0} + {\sum }_{j = 1 , i = 1}^{N} {α}_{ij} * {PCS}_{j}^{t - 1} ,$$
wherein
N is a total number of the users in the user group, PCSᵢ^{t} is a credit scoring value updated fort times of an ith user, αᵢⱼ is an intimacy level value between the ith user and a jth user, and the intimacy level value representing intimacy of the social relationship between the two users, PCSⱼ^{t-1} is a credit scoring value updated for t−1 times of the jth user, and PCSᵢ⁰ an initial credit scoring value of the ith user.

9. The device according to claim 7, wherein the processor is further configured to:
determine whether a difference between the current credit scoring value of each user in the user group and the previous credit scoring value that is after an iterative update is smaller than a threshold, if yes, determine that the current credit scoring value of each user in the user group meets the preset convergence result, and if not, determine that the updated credit scoring value of each user in the user group does not meet the preset convergence result.

10. The device according to claim 6, wherein the processor is further configured to:
initialize the user group to be a null value, and determine the target user as a specified user;
obtain a friend list in a social network of the specified user;
determine whether the obtained friend list has a new user, wherein the new user is a user that does not exist in the user group, if yes, implement a fourth user group obtaining subunit, and if not, end the operation; and
add the new user into the user group, determine the new user as the specified user, and then return to implement the second user group obtaining subunit.

11. A non-transitory computer-readable storage medium containing computer-executable program instructions for, when executed by a processor, performing a credit score determining method, the method comprising:
obtaining a user group, comprising multiple users having social relationships, the multiple users containing a target user; and
regarding each user in the user group, determining a current credit scoring value of the user according to a previous credit scoring value, that is after an iterative update, of another user having the social relationship with the user, and performing the iterative update until the current credit scoring value of each user in the user group meets a preset convergence result, wherein the current credit scoring value of the target user is used as a credit scoring value of the target user.

12. The storage medium according to claim 11, wherein, regarding each user in the user group, determining the current credit scoring value of the user comprises:
performing a credit score updating process on each user in the user group, by:
determining a current credit scoring value of the user according to a previous credit scoring value that is after an iterative update of another user having the social relationship with the user; and
determining whether the current credit scoring value of each user in the user group meets the preset convergence result,
when the current credit scoring value of each user in the user group does not meet the preset convergence result, returning to performing the credit score updating process on each user in the user group, and
when the current credit scoring value of each user in the user group meets the preset convergence result, ending the operation.

13. The storage medium according to claim 12, wherein determining the current credit scoring value of the user according to the previous credit scoring value that is after the iterative update of the another user having the social relationship with the user comprises:
determining the current credit scoring value of the user according to a formula:
$${PCS}_{i}^{t} = {PCS}_{i}^{0} + {\sum }_{j = 1 , i = 1}^{N} {α}_{ij} * {PCS}_{j}^{t - 1} ,$$
wherein
N is a total number of the users in the user group; PCSᵢ^{t} is a credit scoring value updated fort times of an ith user, αᵢⱼ is an intimacy level value between the ith user and a jth user, and the intimacy level value representing intimacy of the social relationship between the two users, PCSⱼ^{t-1} is a credit scoring value updated for t−1 times of the jth user, and PCSᵢ⁰ is an initial credit scoring value of the ith user.

14. The storage medium according to claim 12, wherein determining whether the current credit scoring value of each user in the user group meets the preset convergence result comprises:
determining whether a difference between the current credit scoring value of each user in the user group and the previous credit scoring value that is after an iterative update is smaller than a threshold, if yes, determining that the current credit scoring value of each user in the user group meets the preset convergence result, and if not, determining that the updated credit scoring value of each user in the user group does not meet the preset convergence result.

15. The storage medium according to claim 11, wherein obtaining the user group comprises:
initializing the user group to merely contain the target user, and determining the target user as a specified user;
obtaining a friend list in a social network of the specified user; and
determining whether the obtained friend list has a new user, wherein the new user is a user that does not exist in the user group,
if yes, adding the new user into the user group, determining the new user as the specified user, and returning to perform the step of the obtaining a friend list in a social network of the specified user, and
if not, ending the operation.
